(19) United States
(12) Patent Application Publication
(10) Pub. No.: US 2023/0189058 A1
(43) Pub. Date: Jun. 15, 2023

(54) RAN-AWARE TRAFFIC DISTRIBUTION RULES AND RAN MEASUREMENTS FOR ENHANCED ACCESS TRAFFIC STEERING SWITCHING AND SPLITTING

(71) Applicant: Intel Corporation, Santa Clara, CA (US)

(72) Inventors: Shu-ping Yeh, Campbell, CA (US); Jingwen Bai, San Jose, CA (US); Jing Zhu, Portland, OR (US); Meghashree Dattatri Kedalagudde, Portland, OR (US); Binita Gupta, San Diego, CA (US); Necati Canpolat, Beaverton, OR (US)

(21) Appl. No.: 17/925,430

(22) PCT Filed: Jun. 25, 2021
(86) PCT No.: PCT/US2021/039253

§ 371 Date: Nov. 15, 2022

Related U.S. Application Data
(60) Provisional application No. 63/047,838, filed on Jul. 2, 2020.

(51) Int. Cl. H04W 28/02; H04W 28/086; H04W 48/18; H04W 24/10

(52) U.S. Cl. CPC H04W 28/0289; H04W 24/10; H04W 28/0819; H04W 48/18

(57) ABSTRACT

Present disclosure may relate to an apparatus comprising: memory to store ran access network (RAN) load indicator information or user equipment (UE)-specific RAN condition indicator information; and processing circuitry, coupled with the memory, to: retrieve the RAN load indicator information or UE-specific RAN condition indicator information from the memory; and encode a measurement report message for transmission that includes the RAN load indicator information or UE-specific RAN condition indicator information.

### CROSS REFERENCE TO RELATED APPLICATION

The present application claims priority to U.S. Provisional Pat. Application No. 63/047,838, which was filed Jul. 2, 2020.

### FIELD

Various embodiments generally may relate to the field of wireless communications. For example, some embodiments may relate to incorporating RAN measurements when determining traffic distribution across 3GPP and non-3GPP access for ATSSS.

### BACKGROUND

The ATSSS (Access Traffic Steering Switching and Splitting) feature enables a UE (User Equipment) to simultaneously connect to both 3GPP access and non-3GPP access. To take full advantage of both accesses, the 5G system should be able to distribute traffic across two accesses in a manner that improves user experience with efficient radio resource usage. RAN (Radio Access Network) measurements can provide information such as radio link quality, delay statistics, etc., that can be used for the 5G system to compare different radio access technologies when determining how traffic should be distributed across accesses.

### BRIEF DESCRIPTION OF THE FIGURES

FIG. 1 illustrates an example of tail delay (95%-th delay) performance for RAN-aware and RAN-unaware multi-access traffic distribution schemes under different cellular and Wi-Fi settings in accordance with various embodiments.

FIG. 2 illustrates a network in accordance with various embodiments.

FIG. 3 illustrates a wireless network in accordance with various embodiments.

FIG. 4 is a block diagram illustrating components, according to some example embodiments, able to read instructions from a machine-readable or computer-readable medium (e.g., a non-transitory machine-readable storage medium) and perform any one or more of the methodologies discussed herein.

FIG. 5 depicts an example procedure for practicing the various embodiments discussed herein.

FIG. 6 depicts another example procedure for practicing the various embodiments.

FIG. 7 depicts another example procedure for practicing the various embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

In this disclosure, we propose to enhance ATSSS rules to incorporate RAN measurements when determining traffic distribution across 3GPP and non-3GPP access. We identified the RAN measurements to be collected and how to use these RAN measurements as guidelines when adjusting traffic distribution rules.

Existing ATSSS rules do not consider incorporating RAN measurements to improve radio efficiency while distributing traffic across 3GPP and non-3GPP access networks. Currently ATSSS only supports 4 traffic steering modes: Active-Standby, Smallest Delay, Load-Balancing, and Priority-based. The existing traffic steering modes support concurrent use of 3GPP and non-3GPP access and dynamic change of traffic distribution according to RAT (radio access technology) availability and delay measurements. However, there is no existing mechanism allowing dynamic adjustment of traffic distribution across 3GPP and non-3GPP access based on access network radio condition or congestion level.

Past solutions can only adjust traffic distribution across 3GPP and non-3GPP access after detecting noticeable network performance degradation, such as an access link becomes unavailable or change in delay measurements (usually averaged over a certain time window to smooth out short-term fluctuation) across links. Those mechanisms can only adapt to access network quality in a reactive manner and it usually takes longer time scale to detect access network performance degradation.

Among other things, embodiments of the present disclosure may incorporate RAN measurements when determining traffic distribution across 3GPP and non-3GPP access for ATSSS. Specifically, some embodiments may include new candidate RAN measurements to be incorporated in RAN-Aware ATSSS rules and multiple implementation proposals to incorporate RAN measurements in RAN-aware ATSSS rules.

By incorporating RAN-measurements, the network can proactively adjust traffic distribution across 3GPP and non-3GPP access according to more accurate access performance (rate, latency, etc.) estimate. This enables more efficient use of multiple access technologies and better quality-of-service (QoS) guarantee through tight multiple access traffic management, and helps enhance multi-access edge computing (MEC).

### RAN-Aware Multi-Access Traffic Management

Among other things, RAN measurements can provide timely indication of radio condition to multi-access traffic management intelligence at the core or edge. For example, when degradation in radio link quality occurs, it may take a lot of packet transmissions to detect delay increase caused by poor radio link quality for delay-based reactive traffic management schemes. On the other hand, proactive RAN-Aware traffic management scheme can utilize radio link measurements from RAN to timely identify if there is an access experiencing poor radio condition.

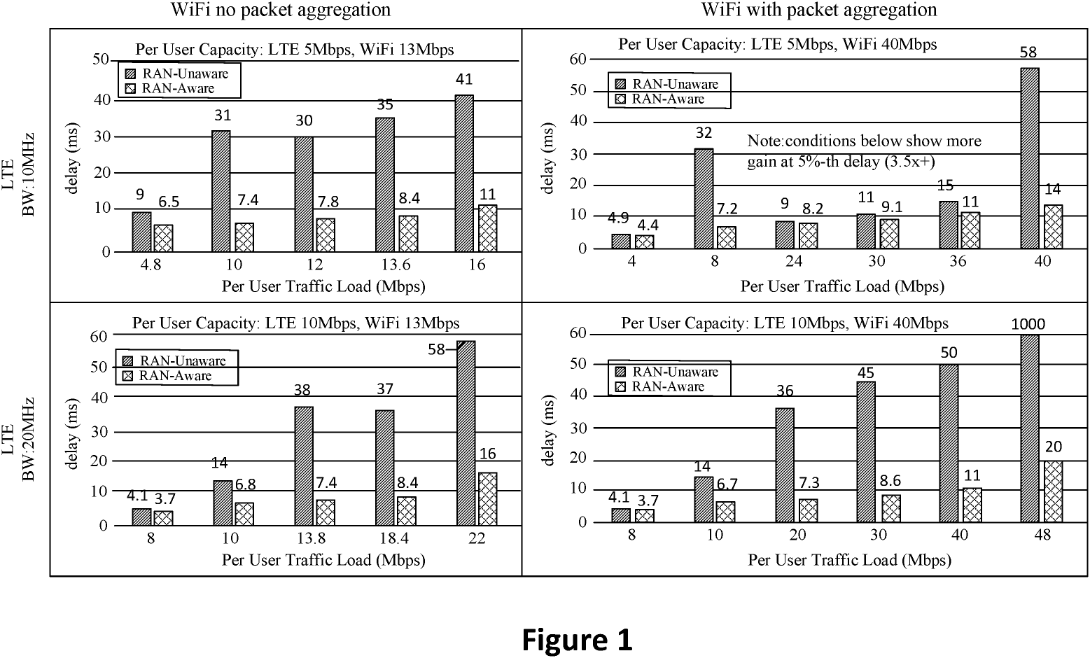

Some embodiments may utilize edge-based algorithms that incorporate RAN information to compute delay-optimal traffic distribution across multiple access links. In some embodiments, packet delay statistics can be greatly improved with RAN measurement information when compared with RAN-Unaware delay-based reactive traffic adaptation schemes, such as MP-TCP (Multipath Transport Control Protocol). As shown in FIG. 1, RAN-Aware traffic management algorithm can significantly reduce tail (95%-th) delay for different LTE and Wi-Fi deployment settings, especially under heavier traffic loading conditions.

Embodiments of this disclosure may include new RAN measurements to be added to 3GPP spec to enable RAN-Aware multi-access traffic distribution and how to incorporate the new RAN measurements to update ATSSS traffic distribution. Embodiments may use any suitable signaling to enable RAN-Aware ATSSS. NG-RAN and UE can both provide ATSSS RAN Measurement Report to help UPF (User Plane Function) and UE update traffic distribution for flows within a MA-PDU (Multi-Access Protocol Data Unit) session. This disclosure proceeds by first describing what can be included in an ATSSS RAN Measurement Report and then provides candidate implementations that incorporate RAN measurements to update traffic distribution across 3GPP and non-3GPP access for flows belonged to a MA-PDU session.

### RAN Measurement Report Information Element

In some embodiments, the ATSSS RAN Measurement Report (from NG-RAN or from UE) may contain one or both of the following two types of information elements:
1. Radio Access Network load indicator
2. UE-specific RAN condition indicator

### Radio Access Network Load Indicator

Congestion in radio access network leads to performance degradation such as increased latency. By providing radio access network loading conditions of 3GPP and non-3GPP access networks, ATSSS rules such as Load-Balancing with RAN measurement and Priority-Based with RAN measurement can timely adjust traffic distribution ratio between 3GPP and non-3GPP access, achieving better delay performance. PRB (Physical Resource Block) usage of NGRAN and channel utilization level of Wi-Fi access are good indicators for the congestion level of Radio Access Network. For example, flows sent over a cell with high PRB usage level have higher risk of large delay variation (jittering).

For NG-RAN, the radio access network load indicator can be the radio resource utilization measurements, such as DL/UL Total PRB usage and per QoS class DL/UL PRB usage. This type of measurement is reported from NG-RAN (e.g., N2 signaling).
DL (or UL) Total PRB Usage:
$$M \left(T\right) = \left⌊\frac{M 1 \left(T\right)}{P \left(T\right)} ∗ 100\right⌋$$
where ^{M(T)}is the DL (or UL) total PRB usage, which is percentage of PRBs used, averaged during time period T with value range: 0-100%; ^{M1(T)}is a count of full physical resource blocks and all PRBs used for DL (or UL) traffic transmission shall be included; ^{P(T)}is total number of PRBs available for DL (or UL) traffic transmission during time period ^{T} ; and ^{T}is the time period during which the measurement is performed.
$$M \left(q c i\right) = \left⌊\frac{M 1 \left(q c i , T\right)}{P \left(T\right)} ∗ 100\right⌋$$
PRB usage per traffic class: where ^{M(qci)}is PRB usage per traffic class, which is percentage of PRBs used for a certain qci, averaged during a time period ^{T} with value range: 0-100%; ^{P(T)}is total number of PRBs available for DL (or UL) traffic transmission during time period ^{T}; and ^{T}is the time period during which the measurement is performed; ^{M1}(^{qci}’^{T)}is absolute PRB usage per traffic class, calculated by
$$M 1 \left(q c i , T\right) = {\sum }_{∀ t} {\sum }_{∀ p ∈ S \left(t\right)} \frac{1}{W \left(p\right)} ∗ X \left(t\right) ∗ \frac{B \left(t , q c i\right)}{B \left(t\right)}$$
where ^{W(P)} is the number of transport blocks that are currently sharing PRB ^{P}; ^{S(t)} is the set of physical resource blocks used for transmission of transport block ^{t;}^{B}^{(t,qci)} is the total number of DTCH (Dedicated Traffic Channel) bits for DTCHs with QCI =^{qci}, carried in transport block ^{t} and ^{B(t)} is the total number of DTCH and DCCH bits carried in transport block ^{t;}^{X(t)} takes into account of multiplexing and whether to include it is up to implementation.

For WLAN, the radio access network load indicator can be the:
BSS (infrastructure mode wireless network Basic Service Set) load element in Wi-Fi AP (access point) beacon message:
STA (station) Count: the total number of STAs currently associated with this BSS.
Channel Utilization: the percentage of time that the AP sensed the medium was busy. This percentage is computed using the formula:
$$\begin{matrix}\text{Channel Utilization} = \\ \left⌊\frac{\text{channel busy time}}{\text{dot11ChannelUtilizationBeaconIntervals} \times \text{dot11BeaconPeriod} \times \text{1024}} \times 255\right⌋\end{matrix}$$
RAN load indicator for WLAN can further include Estimated Service Parameters (ESP), which includes estimated throughput for available access categories, estimate of air time fraction, Block Ack Window size, data PPDU duration target.

WLAN radio access network load indicator can be reported by either WLAN through N2 signaling or by STA via PMF in-band signaling.
UE-specific RAN condition indicator

In addition to aggregated Radio Access network load condition indication, per UE RAN condition metric can be usefully for sorting UEs while determining traffic splitting ratios for multiple UEs simultaneously establishing MA-PDU session with the same 3GPP and non-3GPP radio access nodes. We propose the following candidate metrics to be included in UE-specific RAN condition indicator:

### UE Radio Signal Quality

For NG-RAN, the UE may use RSRP (Reference Signal Received Power), RSRQ (Reference Signal Received Quality), average/median CQI (Channel Quality Indicator) index or average MAC data rate as its radio signal quality indication. UE radio signaling quality can be reported directly from UE via PMF in-band signaling or be reported by NG-RAN based on UE measurement report and/or CQI feedback statistics.

For WLAN, the UE may use its RSSI (Received Signal Strength Indicator) or average/median PHY (physical layer) rate (MCS (modulation and coding scheme) level) as its radio signal quality indication. UE can report radio signaling quality via PMF in-band signaling.

Alternatively, the AP can also report the following STA specific metrics:
Estimated MAC Data Rate in downlink (in Mb/s) for the STA
Estimated MAC Data Rate in uplink (in Mb/s) for the STA
Measured uplink RSSI for the STA (dBm)

### UE Per RAT Radio Resource Utilization: (New Signaling With RAN Impact)

A new RAN measurement, UE per RAT radio resource utilization, can be defined to capture the efficiency of radio usage of a UE with MA-PDU session. For NG-RAN, UE per RAT radio resource utilization can be captured by PRB usage per UE, which can be calculated as follows:

$$M \left(u e\right) = \left⌊\frac{M 1 \left(u e , T\right)}{P \left(T\right)} ∗ 100\right⌋ ,$$

where M(ue) is PRB usage per UE, which is the percentage of PRBs used for a certain UE with MA-PDU; M1(ue,T) is a count of all physical resource blocks used for DL (or UL) traffic transmission for the ATSSS UE; P(T) is total number of PRBs available for DL (or UL) traffic transmission during time period T; and T is the time period during which the measurement is performed.

For WLAN, STA may estimate radio resource utilization by calculating the average time duration the STA is actively receiving data from the AP (or transmitting data to the AP for UL) over several beacon interval:

STA Utilization Level

$$= \left⌊\frac{\text{Duration of STA receving data}}{\text{dot11ChannelUtilizationBeaconIntervals} \times \text{dot11BeaconPeriod} \times \text{1024}} \times 255\right⌋$$

### ATSSS Rules With RAN Measurements

In the following, the disclosure describes different implementations of how ATSSS rules can incorporate RAN measurements to adapt traffic distribution to enhance user experience.

### Implementation 1: Use of Radio Access Network Load Indicator

When RAN feedback measurement for ATSSS is allowed, the SMF (Session Management Function) may decide to update ATSSS rules and/or N4 rules based on the Radio Access Network load indicator in RAN Measurement Report received from NG-RAN. For example, SMF can calculate RAN-load thresholds of a MA-PDU SDF (Service Data Flow) for 3GPP and non-3GPP access networks based on the QoS requirements of the SDF. Alternatively, the RAN-load thresholds can be provided via PCF (Policy Control Function). SMF determines the percentage of the SDF traffic that should be sent over 3GPP access and over non-3GPP access by comparing the received Radio Access Network load indicators and the RAN-load thresholds for 3GPP and non-3GPP access. Denote the RAN-load thresholds for 3GPP and non-3GPP accesses as THᵣ₁,₃ and THᵣ₁,ₙ₃. Denote the received Radio Access Network load indicators for 3GPP and non-3GPP accesses as RLI3 and RLIₙ₃. An example implementation can be:
If RLI₃<THᵣ₁,₃ and RLIₙ₃<THᵣ₁,ₙ₃, x% of traffic should be routed to 3GPP access and (100-x)% of traffic should be routed to non-3GPP access, where 0≤x≤100.

If RLI₃<THᵣ₁,₃ and RLIₙ₃>THᵣ₁,ₙ₃, (x+Δ1)% of traffic should be routed to 3GPP access and (100-x-Δ1)% of traffic should be routed to non-3GPP access, where 0≤Δ1≤100-x. (Note: move more traffic to 3GPP access since RAN load indicator suggests non-3GPP access is congested.)

If RLI₃>TH_{r1,3} and RLIₙ₃<THᵣ₁,ₙ₃, (x-Δ₂)% of traffic should be routed to 3GPP access and (100-_{X}+Δ₂)% of traffic should be routed to non-3GPP access, where 0≤Δ_{2≤}x. (Note: move more traffic to non-3GPP access since RAN load indicator suggests 3GPP access is congested.)

If RLI₃>THᵣ₁,₃ and RLIₙ₃>THᵣ₁,ₙ₃, y% of traffic should be routed to 3GPP access and (100-y)% of traffic should be routed to non-3GPP access, where x-Δ2≤y≤ x+Δ1.

### Implementation 2: Use of Congestion Detection + UE-Specific RAN Condition Indicator

In addition to congestion detection, to achieve more efficient radio usage while there are multiple ATSSS UEs sharing the same 3GPP and non-3GPP accesses, UE-specific RAN condition indicator can provide better guidance on which UE’s MA-PDU SDF traffic distribution should be adjusted first when congestion of one access occurs. For example, consider a scenario where there are two ATSSS-capable UEs, both simultaneously connecting to the same gNB and Wi-Fi AP. UE 1 has better radio quality for NR radio than UE 2, but the Wi-Fi radio quality for UE 2 is better than UE 1. When congestion is detected on Wi-Fi radio and both UE have ongoing traffic on Wi-Fi, steering part or all of UE 1 traffic from Wi-Fi to NR can more efficiently use NR spectrum to alleviate congestion on Wi-Fi than adjusting UE 2 traffic distribution.

When RAN feedback measurement for ATSSS is allowed, the SMF may decide to update ATSSS rules and/or N4 rules based on the UE-specific RAN condition indicator in RAN Measurement Report received from NG-RAN. There can be three types of new ATSSS rules (labeled Implementations 2.1, 2.2, and 2.3, below):

### Implementation 2.1

(Both congestion detection and UE radio condition assessment are done by SMF) SMF determines the percentage of the SDF traffic that should be sent over 3GPP access and over non-3GPP access based on UE-specific RAN condition indicator reports and congestion detection mechanism, such as using RAN load indicator as described in Example 1. For example, SMF can calculate UE-specific RAN condition thresholds of a MA-PDU SDF for 3GPP and non-3GPP access networks based on the QoS requirements of the SDF. Alternatively, the UE-specific RAN condition thresholds can be provided via PCF. When congestion of one access is detected, SMF updates the percentage of the SDF traffic that should be sent over 3GPP access and over non-3GPP access by comparing the received UE-specific RAN condition indicators and the UE-specific RAN condition thresholds for 3GPP and non-3GPP access. Denote the UE-specific RAN condition thresholds for 3GPP and non-3GPP accesses as THurc,3 and THurc,n3. Denote the received UE-specific RAN condition indicators for 3GPP and non-3GPP accesses as URCI3 and URCIn3. An example implementation can be:

When congestion on non-3GPP access is detected, update the traffic distribution of a SDF belonging to a UE with URCI3>THurc,3 and URCIn3<THurc,n3 (good 3GPP link & bad non-3GPP link) by increasing percentage of traffic routed to 3GPP access from x% to (x+Δ1)% and decreasing percentage of traffic routed to non-3GPP access from (100-x)% to (100-x-Δ1)%, where 0≤x≤100 and 0≤Δ1≤100-x.

When congestion on 3GPP access is detected, update the traffic distribution of a SDF belonging to a UE with URCI3<THurc,3 and URCIn3>THurc,n3 (bad 3GPP link & good non-3GPP link) by decreasing percentage of traffic routed to 3GPP access from x% to (x-Δ₂)% and increasing percentage of traffic routed to non-3GPP access from (100-x)% to (100-x+Δ2)%, where 0≤x≤100 and 0≤Δ2≤x.

### Implementation 2.2

(UPF and UE perform congestion detection and SMF access UE radio condition) SMF configures priority-based with RAN-measurement ATSSS rule that specifies how the percentage of the SDF traffic to be sent over 3GPP access and over non-3GPP access should be updated based on congestion detection mechanism implemented by UPF and UE user plane. For example, UPF and UE user plane congestion detection can be based on delay measurements from PMF. SMF determines the priority-based with RAN-measurement ATSSS rule for individual MA-PDU SDF based on UE RAN condition indicator and SDF QoS requirements. For example, SMF or PCF may configure UE-specific RAN condition thresholds as described previously in example 2.1. By comparing the received UE-specific RAN condition indicators and the UE-specific RAN condition thresholds for 3GPP and non-3GPP access, SMF identifies which set of UE should prioritize 3GPP access, which set of UE should prioritized non-3GPP access and which set of UE should update traffic distribution if congestion on prioritized access is detected. An example implementation can be,

A SDF belonged to a UE with URCI3>THurc,3 (good 3GPP link) can be configured to prioritize 3GPP access; a SDF belonged to a UE with URCI3<THurc,3 (bad 3GPP link) can be configured to prioritize non-3GPP access.

In addition, if the URCIn3>THurc,n3 (good non-3GPP link), the SDF can be configured to move 3GPP load over to non-3GPP access when congestion on 3GPP access is detected.

In addition, if the URCIn3<THurc,n3 (bad non-3GPP link), the SDF can be configured to move non-3GPP load over to 3GPP access when congestion on non-3GPP access is detected.

Alternative implementation can be: A SDF belonged to a UE with URCIn3>THurc,n3 (good non-3GPP link) can be configured to prioritize non-3GPP access; a SDF belonged to a UE with URCIn3<THurc,n3 (bad non-3GPP link) can be configured to prioritize 3GPP access.

In addition, if the URCI3>THur,3 (good 3GPP link), the SDF can be configured to move non-3GPP load over to 3GPP access when congestion on non-3GPP access is detected.

In addition, if the URCI3<THurc,3 (bad 3GPP link), the SDF can be configured to move 3GPP load over to non-3GPP access when congestion on 3GPP access is detected.

### Implementation 2.3

(UPF and UE perform congestion detection and monitor UE radio condition) SMF configures priority-based with RAN-measurement ATSSS rule that specifies how the percentage of the SDF traffic to be sent over 3GPP access and over non-3GPP access should be updated based on congestion detection mechanism implemented by UPF and UE user plane and the UE radio condition measured for 3GPP and non-3GPP access. For example, SMF configures the UE-specific RAN condition thresholds for 3GPP and non-3GPP access in the ATSSS rule of a SDF. The percentage of traffic to be sent over 3GPP and non-3GPP access is then adjusted according to the rule specified by SMF. For example:

When congestion on non-3GPP access is detected and received UE-specific RAN condition indicators satisfy URCI3>THurc,3 and URCIn3<THurc,n3 (good 3GPP link & bad non-3GPP link), update the SDF traffic distribution by increasing percentage of traffic routed to 3GPP access from x% to (x+Δ1)% and decreasing percentage of traffic routed to non-3GPP access from (100-x)% to (100-x-Δ1)%, where 0≤x≤100 and 0≤Δ1≤100-x.

When congestion on 3GPP access is detected and received UE-specific RAN condition indicators satisfy URCI3<THurc,3 and URCIn3>THurc,n3 (bad 3GPP link & good non-3GPP link), update the SDF traffic distribution by decreasing percentage of traffic routed to 3GPP access from x% to (x-Δ₂)% and increasing percentage of traffic routed to non-3GPP access from (100-x)% to (100-x+Δ2)%, where 0≤x≤100 and 0≤Δ2≤x.

### Systems and Implementations

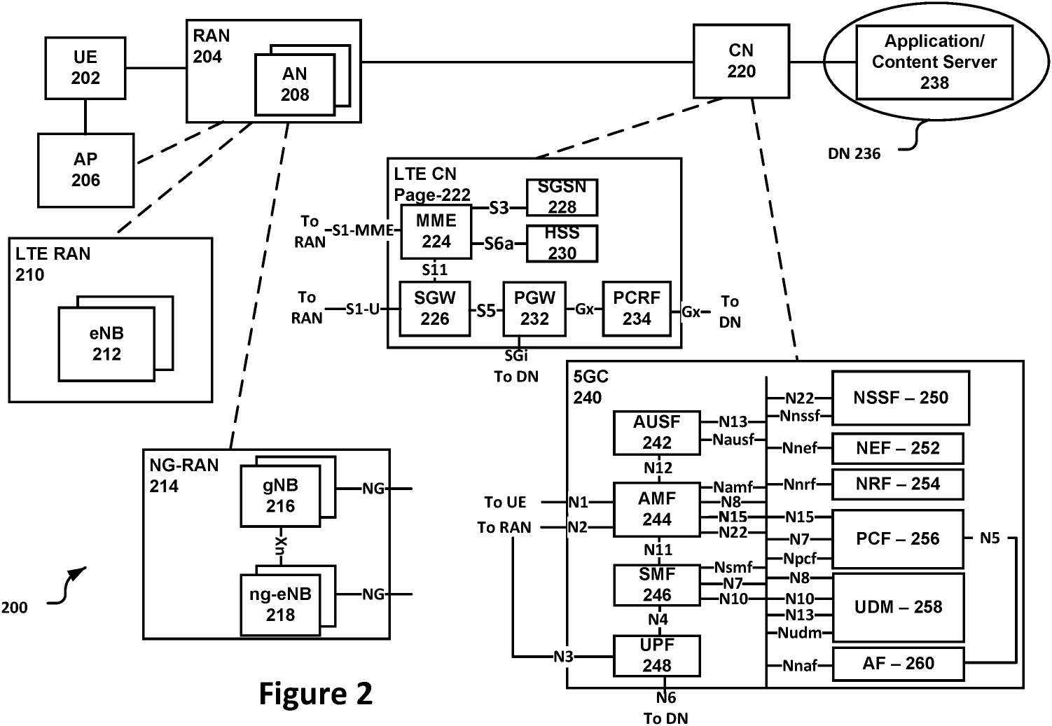

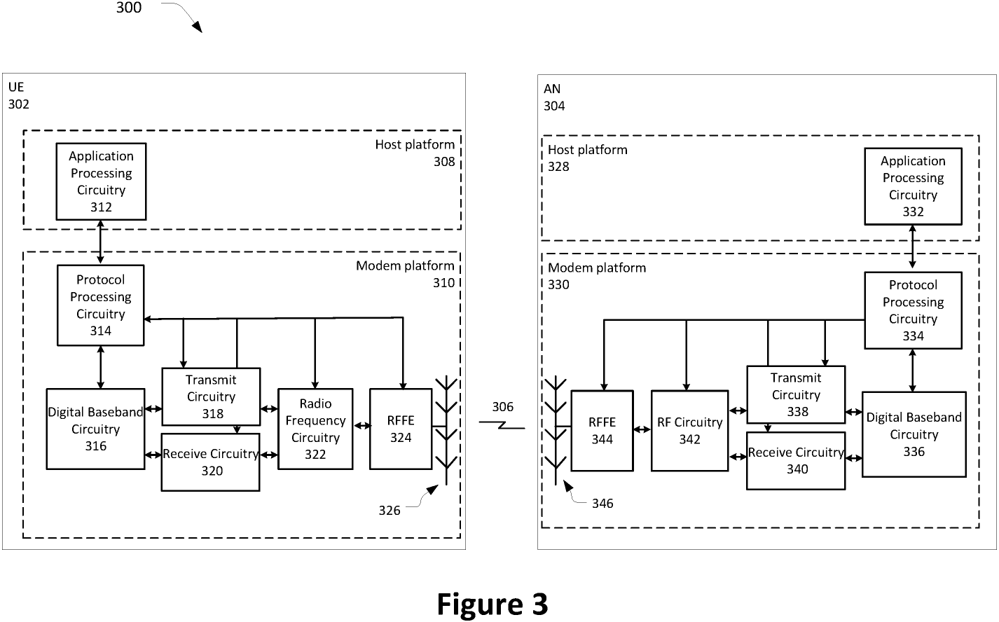

FIGS. 2-3 illustrate various systems, devices, and components that may implement aspects of disclosed embodiments.

FIG. 2 illustrates a network 200 in accordance with various embodiments. The network 200 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 200 may include a UE 202, which may include any mobile or non-mobile computing device designed to communicate with a RAN 204 via an over-the-air connection. The UE 202 may be communicatively coupled with the RAN 204 by a Uu interface. The UE 202 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 200 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 202 may additionally communicate with an AP 206 via an over-the-air connection. The AP 206 may manage a WLAN connection, which may serve to offload some/all network traffic from the RAN 204. The connection between the UE 202 and the AP 206 may be consistent with any IEEE 802.11 protocol, wherein the AP 206 could be a wireless fidelity (Wi-Fi®) router. In some embodiments, the UE 202, RAN 204, and AP 206 may utilize cellular-WLAN aggregation (for example, LWA/LWIP). Cellular-WLAN aggregation may involve the UE 202 being configured by the RAN 204 to utilize both cellular radio resources and WLAN resources.

The RAN 204 may include one or more access nodes, for example, AN 208. AN 208 may terminate air-interface protocols for the UE 202 by providing access stratum protocols including RRC, PDCP, RLC, MAC, and L1 protocols. In this manner, the AN 208 may enable data/voice connectivity between CN 220 and the UE 202. In some embodiments, the AN 208 may be implemented in a discrete device or as one or more software entities running on server computers as part of, for example, a virtual network, which may be referred to as a CRAN or virtual baseband unit pool. The AN 208 be referred to as a BS, gNB, RAN node, eNB, ng-eNB, NodeB, RSU, TRxP, TRP, etc. The AN 208 may be a macrocell base station or a low power base station for providing femtocells, picocells or other like cells having smaller coverage areas, smaller user capacity, or higher bandwidth compared to macrocells.

In embodiments in which the RAN 204 includes a plurality of ANs, they may be coupled with one another via an X2 interface (if the RAN 204 is an LTE RAN) or an Xn interface (if the RAN 204 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 204 may each manage one or more cells, cell groups, component carriers, etc. to provide the UE 202 with an air interface for network access. The UE 202 may be simultaneously connected with a plurality of cells provided by the same or different ANs of the RAN 204. For example, the UE 202 and RAN 204 may use carrier aggregation to allow the UE 202 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 204 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 202 or AN 208 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 204 may be an LTE RAN 210 with eNBs, for example, eNB 212. The LTE RAN 210 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 204 may be an NG-RAN 214 with gNBs, for example, gNB 216, or ng-eNBs, for example, ng-eNB 218. The gNB 216 may connect with 5G-enabled UEs using a 5G NR interface. The gNB 216 may connect with a 5G core through an NG interface, which may include an N2 interface or an N3 interface. The ng-eNB 218 may also connect with the 5G core through an NG interface, but may connect with a UE via an LTE air interface. The gNB 216 and the ng-eNB 218 may connect with each other over an Xn interface.

In some embodiments, the NG interface may be split into two parts, an NG user plane (NG-U) interface, which carries traffic data between the nodes of the NG-RAN 214 and a UPF 248 (e.g., N3 interface), and an NG control plane (NG-C) interface, which is a signaling interface between the nodes of the NG-RAN214 and an AMF 244 (e.g., N2 interface).

The NG-RAN 214 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 202 can be configured with multiple BWPs where each BWP configuration has a different SCS. When a BWP change is indicated to the UE 202, the SCS of the transmission is changed as well. Another use case example of BWP is related to power saving. In particular, multiple BWPs can be configured for the UE 202 with different amount of frequency resources (for example, PRBs) to support data transmission under different traffic loading scenarios. A BWP containing a smaller number of PRBs can be used for data transmission with small traffic load while allowing power saving at the UE 202 and in some cases at the gNB 216. A BWP containing a larger number of PRBs can be used for scenarios with higher traffic load.

The RAN 204 is communicatively coupled to CN 220 that includes network elements to provide various functions to support data and telecommunications services to customers/subscribers (for example, users of UE 202). The components of the CN 220 may be implemented in one physical node or separate physical nodes. In some embodiments, NFV may be utilized to virtualize any or all of the functions provided by the network elements of the CN 220 onto physical compute/storage resources in servers, switches, etc. A logical instantiation of the CN 220 may be referred to as a network slice, and a logical instantiation of a portion of the CN 220 may be referred to as a network sub-slice.

In some embodiments, the CN 220 may be an LTE CN 222, which may also be referred to as an EPC. The LTE CN 222 may include MME 224, SGW 226, SGSN 228, HSS 230, PGW 232, and PCRF 234 coupled with one another over interfaces (or “reference points”) as shown. Functions of the elements of the LTE CN 222 may be briefly introduced as follows.

The MME 224 may implement mobility management functions to track a current location of the UE 202 to facilitate paging, bearer activation/deactivation, handovers, gateway selection, authentication, etc.

The SGW 226 may terminate an S1 interface toward the RAN and route data packets between the RAN and the LTE CN 222. The SGW 226 may be a local mobility anchor point for inter-RAN node handovers and also may provide an anchor for inter-3GPP mobility. Other responsibilities may include lawful intercept, charging, and some policy enforcement.

The SGSN 228 may track a location of the UE 202 and perform security functions and access control. In addition, the SGSN 228 may perform inter-EPC node signaling for mobility between different RAT networks; PDN and S-GW selection as specified by MME 224; MME selection for handovers; etc. The S3 reference point between the MME 224 and the SGSN 228 may enable user and bearer information exchange for inter-3GPP access network mobility in idle/active states.

The HSS 230 may include a database for network users, including subscription-related information to support the network entities’ handling of communication sessions. The HSS 230 can provide support for routing/roaming, authentication, authorization, naming/addressing resolution, location dependencies, etc. An S6a reference point between the HSS 230 and the MME 224 may enable transfer of subscription and authentication data for authenticating/authorizing user access to the LTE CN 220.

The PGW 232 may terminate an SGi interface toward a data network (DN) 236 that may include an application/content server 238. The PGW 232 may route data packets between the LTE CN 222 and the data network 236. The PGW 232 may be coupled with the SGW 226 by an S5 reference point to facilitate user plane tunneling and tunnel management. The PGW 232 may further include a node for policy enforcement and charging data collection (for example, PCEF). Additionally, the SGi reference point between the PGW 232 and the data network 236 may be an operator external public, a private PDN, or an intra-operator packet data network, for example, for provision of IMS services. The PGW 232 may be coupled with a PCRF 234 via a Gx reference point.

The PCRF 234 is the policy and charging control element of the LTE CN 222. The PCRF 234 may be communicatively coupled to the app/content server 238 to determine appropriate QoS and charging parameters for service flows. The PCRF 232 may provision associated rules into a PCEF (via Gx reference point) with appropriate TFT and QCI.

In some embodiments, the CN 220 may be a 5GC 240. The 5GC 240 may include an AUSF 242, AMF 244, SMF 246, UPF 248, NSSF 250, NEF 252, NRF 254, PCF 256, UDM 258, and AF 260 coupled with one another over interfaces (or “reference points”) as shown. Functions of the elements of the 5GC 240 may be briefly introduced as follows.

The AUSF 242 may store data for authentication of UE 202 and handle authentication-related functionality. The AUSF 242 may facilitate a common authentication framework for various access types. In addition to communicating with other elements of the 5GC 240 over reference points as shown, the AUSF 242 may exhibit an Nausf service-based interface.

The AMF 244 may allow other functions of the 5GC 240 to communicate with the UE 202 and the RAN 204 and to subscribe to notifications about mobility events with respect to the UE 202. The AMF 244 may be responsible for registration management (for example, for registering UE 202), connection management, reachability management, mobility management, lawful interception of AMF-related events, and access authentication and authorization. The AMF 244 may provide transport for SM messages between the UE 202 and the SMF 246, and act as a transparent proxy for routing SM messages. AMF 244 may also provide transport for SMS messages between UE 202 and an SMSF. AMF 244 may interact with the AUSF 242 and the UE 202 to perform various security anchor and context management functions. Furthermore, AMF 244 may be a termination point of a RAN CP interface, which may include or be an N2 reference point between the RAN 204 and the AMF 244; and the AMF 244 may be a termination point of NAS (N1) signaling, and perform NAS ciphering and integrity protection. AMF 244 may also support NAS signaling with the UE 202 over an N3 IWF interface.

The SMF 246 may be responsible for SM (for example, session establishment, tunnel management between UPF 248 and AN 208); UE IP address allocation and management (including optional authorization); selection and control of UP function; configuring traffic steering at UPF 248 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 244 over N2 to AN 208; and determining SSC mode of a session. SM may refer to management of a PDU session, and a PDU session or “session” may refer to a PDU connectivity service that provides or enables the exchange of PDUs between the UE 202 and the data network 236.

The UPF 248 may act as an anchor point for intra-RAT and inter-RAT mobility, an external PDU session point of interconnect to data network 236, and a branching point to support multi-homed PDU session. The UPF 248 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 248 may include an uplink classifier to support routing traffic flows to a data network.

The NSSF 250 may select a set of network slice instances serving the UE 202. The NSSF 250 may also determine allowed NSSAI and the mapping to the subscribed S-NSSAIs, if needed. The NSSF 250 may also determine the AMF set to be used to serve the UE 202, or a list of candidate AMFs based on a suitable configuration and possibly by querying the NRF 254. The selection of a set of network slice instances for the UE 202 may be triggered by the AMF 244 with which the UE 202 is registered by interacting with the NSSF 250, which may lead to a change of AMF. The NSSF 250 may interact with the AMF 244 via an N22 reference point; and may communicate with another NSSF in a visited network via an N31 reference point (not shown). Additionally, the NSSF 250 may exhibit an Nnssf service-based interface.

The NEF 252 may securely expose services and capabilities provided by 3GPP network functions for third party, internal exposure/re-exposure, AFs (e.g., AF 260), edge computing or fog computing systems, etc. In such embodiments, the NEF 252 may authenticate, authorize, or throttle the AFs. NEF 252 may also translate information exchanged with the AF 260 and information exchanged with internal network functions. For example, the NEF 252 may translate between an AF-Service-Identifier and an internal 5GC information. NEF 252 may also receive information from other NFs based on exposed capabilities of other NFs. This information may be stored at the NEF 252 as structured data, or at a data storage NF using standardized interfaces. The stored information can then be re-exposed by the NEF 252 to other NFs and AFs, or used for other purposes such as analytics. Additionally, the NEF 252 may exhibit an Nnef service-based interface.

The NRF 254 may support service discovery functions, receive NF discovery requests from NF instances, and provide the information of the discovered NF instances to the NF instances. NRF 254 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 254 may exhibit the Nnrf service-based interface.

The PCF 256 may provide policy rules to control plane functions to enforce them, and may also support unified policy framework to govern network behavior. The PCF 256 may also implement a front end to access subscription information relevant for policy decisions in a UDR of the UDM 258. In addition to communicating with functions over reference points as shown, the PCF 256 exhibit an Npcf service-based interface.

The UDM 258 may handle subscription-related information to support the network entities’ handling of communication sessions, and may store subscription data of UE 202. For example, subscription data may be communicated via an N8 reference point between the UDM 258 and the AMF 244. The UDM 258 may include two parts, an application front end and a UDR. The UDR may store subscription data and policy data for the UDM 258 and the PCF 256, and/or structured data for exposure and application data (including PFDs for application detection, application request information for multiple UEs 202) for the NEF 252. The Nudr service-based interface may be exhibited by the UDR 221 to allow the UDM 258, PCF 256, and NEF 252 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 258 may exhibit the Nudm service-based interface.

The AF 260 may provide application influence on traffic routing, provide access to NEF, and interact with the policy framework for policy control.

In some embodiments, the 5GC 240 may enable edge computing by selecting operator/3^{rd} party services to be geographically close to a point that the UE 202 is attached to the network. This may reduce latency and load on the network. To provide edge-computing implementations, the 5GC 240 may select a UPF 248 close to the UE 202 and execute traffic steering from the UPF 248 to data network 236 via the N6 interface. This may be based on the UE subscription data, UE location, and information provided by the AF 260. In this way, the AF 260 may influence UPF (re)selection and traffic routing. Based on operator deployment, when AF 260 is considered to be a trusted entity, the network operator may permit AF 260 to interact directly with relevant NFs. Additionally, the AF 260 may exhibit an Naf service-based interface.

The data network 236 may represent various network operator services, Internet access, or third party services that may be provided by one or more servers including, for example, application/content server 238.

FIG. 3 schematically illustrates a wireless network 300 in accordance with various embodiments. The wireless network 300 may include a UE 302 in wireless communication with an AN 304. The UE 302 and AN 304 may be similar to, and substantially interchangeable with, like-named components described elsewhere herein.

The UE 302 may be communicatively coupled with the AN 304 via connection 306. The connection 306 is illustrated as an air interface to enable communicative coupling, and can be consistent with cellular communications protocols such as an LTE protocol or a 5G NR protocol operating at mmWave or sub-6GHz frequencies.

The UE 302 may include a host platform 308 coupled with a modem platform 310. The host platform 308 may include application processing circuitry 312, which may be coupled with protocol processing circuitry 314 of the modem platform 310. The application processing circuitry 312 may run various applications for the UE 302 that source/sink application data. The application processing circuitry 312 may further implement one or more layer operations to transmit/receive application data to/from a data network. These layer operations may include transport (for example UDP) and Internet (for example, IP) operations

The protocol processing circuitry 314 may implement one or more of layer operations to facilitate transmission or reception of data over the connection 306. The layer operations implemented by the protocol processing circuitry 314 may include, for example, MAC, RLC, PDCP, RRC and NAS operations.

The modem platform 310 may further include digital baseband circuitry 316 that may implement one or more layer operations that are “below” layer operations performed by the protocol processing circuitry 314 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 310 may further include transmit circuitry 318, receive circuitry 320, RF circuitry 322, and RF front end (RFFE) 324, which may include or connect to one or more antenna panels 326. Briefly, the transmit circuitry 318 may include a digital-to-analog converter, mixer, intermediate frequency (IF) components, etc.; the receive circuitry 320 may include an analog-to-digital converter, mixer, IF components, etc.; the RF circuitry 322 may include a low-noise amplifier, a power amplifier, power tracking components, etc.; RFFE 324 may include filters (for example, surface/bulk acoustic wave filters), switches, antenna tuners, beamforming components (for example, phase-array antenna components), etc. The selection and arrangement of the components of the transmit circuitry 318, receive circuitry 320, RF circuitry 322, RFFE 324, and antenna panels 326 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 314 may include one or more instances of control circuitry (not shown) to provide control functions for the transmit/receive components.

A UE reception may be established by and via the antenna panels 326, RFFE 324, RF circuitry 322, receive circuitry 320, digital baseband circuitry 316, and protocol processing circuitry 314. In some embodiments, the antenna panels 326 may receive a transmission from the AN 304 by receive-beamforming signals received by a plurality of antennas/antenna elements of the one or more antenna panels 326.

A UE transmission may be established by and via the protocol processing circuitry 314, digital baseband circuitry 316, transmit circuitry 318, RF circuitry 322, RFFE 324, and antenna panels 326. In some embodiments, the transmit components of the UE 304 may apply a spatial filter to the data to be transmitted to form a transmit beam emitted by the antenna elements of the antenna panels 326.

Similar to the UE 302, the AN 304 may include a host platform 328 coupled with a modem platform 330. The host platform 328 may include application processing circuitry 332 coupled with protocol processing circuitry 334 of the modem platform 330. The modem platform may further include digital baseband circuitry 336, transmit circuitry 338, receive circuitry 340, RF circuitry 342, RFFE circuitry 344, and antenna panels 346. The components of the AN 304 may be similar to and substantially interchangeable with like-named components of the UE 302. In addition to performing data transmission/reception as described above, the components of the AN 308 may perform various logical functions that include, for example, RNC functions such as radio bearer management, uplink and downlink dynamic radio resource management, and data packet scheduling.

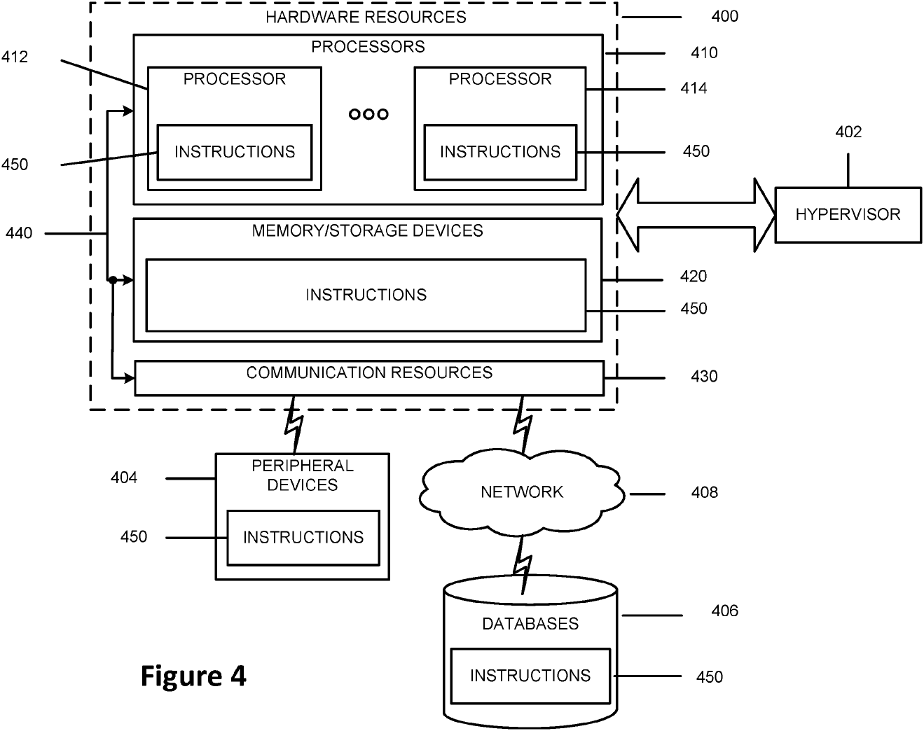

FIG. 4 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 4 shows a diagrammatic representation of hardware resources 400 including one or more processors (or processor cores) 410, one or more memory/storage devices 420, and one or more communication resources 430, each of which may be communicatively coupled via a bus 440 or other interface circuitry. For embodiments where node virtualization (e.g., NFV) is utilized, a hypervisor 402 may be executed to provide an execution environment for one or more network slices/sub-slices to utilize the hardware resources 400.

The processors 410 may include, for example, a processor 412 and a processor 414. The processors 410 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 420 may include main memory, disk storage, or any suitable combination thereof. The memory/storage devices 420 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 430 may include interconnection or network interface controllers, components, or other suitable devices to communicate with one or more peripheral devices 404 or one or more databases 406 or other network elements via a network 408. For example, the communication resources 430 may include wired communication components (e.g., for coupling via USB, Ethernet, etc.), cellular communication components, NFC components, Bluetooth® (or Bluetooth® Low Energy) components, Wi-Fi® components, and other communication components.

Instructions 450 may comprise software, a program, an application, an applet, an app, or other executable code for causing at least any of the processors 410 to perform any one or more of the methodologies discussed herein. The instructions 450 may reside, completely or partially, within at least one of the processors 410 (e.g., within the processor’s cache memory), the memory/storage devices 420, or any suitable combination thereof. Furthermore, any portion of the instructions 450 may be transferred to the hardware resources 400 from any combination of the peripheral devices 404 or the databases 406. Accordingly, the memory of processors 410, the memory/storage devices 420, the peripheral devices 404, and the databases 406 are examples of computer-readable and machine-readable media.

### Example Procedures

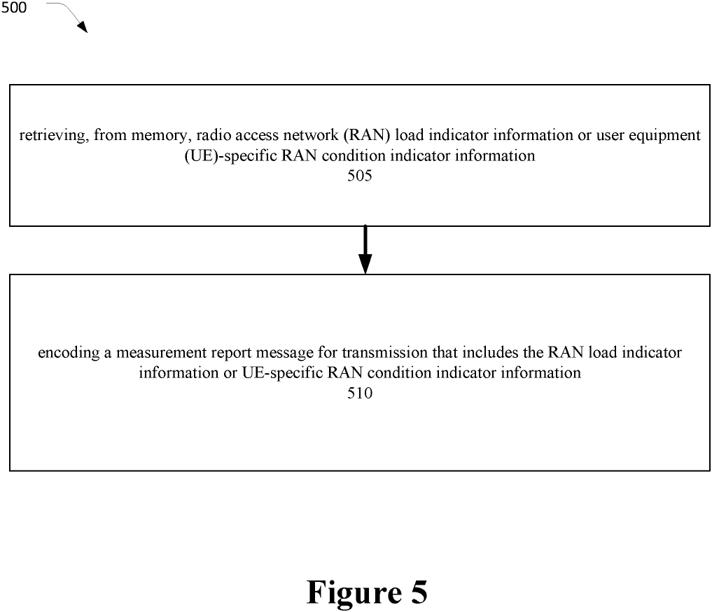

In some embodiments, the electronic device(s), network(s), system(s), chip(s) or component(s), or portions or implementations thereof, of FIGS. 2-4, or some other figure herein, may be configured to perform one or more processes, techniques, or methods as described herein, or portions thereof. One such process is depicted in FIG. 5.

For example, the process 500 may include, at 505, retrieving, from memory, radio access network (RAN) load indicator information or user equipment (UE)-specific RAN condition indicator information. The process further includes, at 510, encoding a measurement report message for transmission that includes the RAN load indicator information or UE-specific RAN condition indicator information.

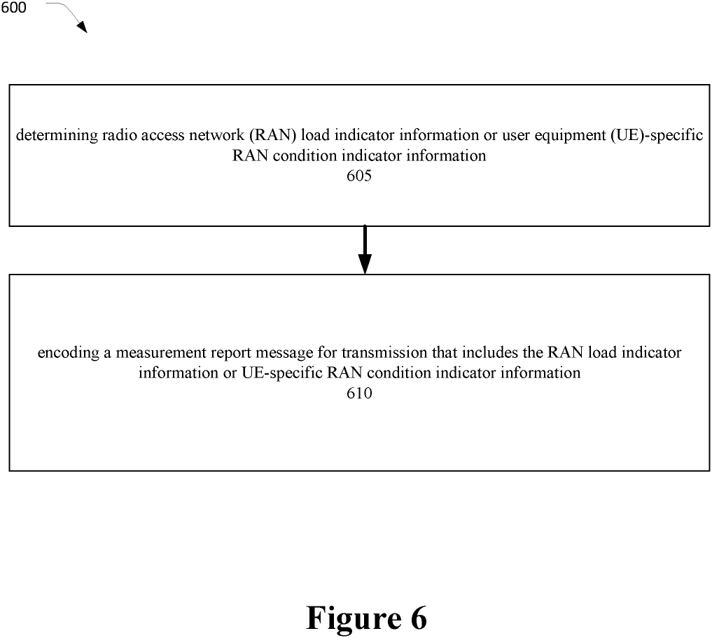

FIG. 6 illustrates another process in accordance with various embodiments. In this example, the process 600 includes, at 605, determining radio access network (RAN) load indicator information or user equipment (UE)-specific RAN condition indicator information. The process further includes, at 610, encoding a measurement report message for transmission that includes the RAN load indicator information or UE-specific RAN condition indicator information.

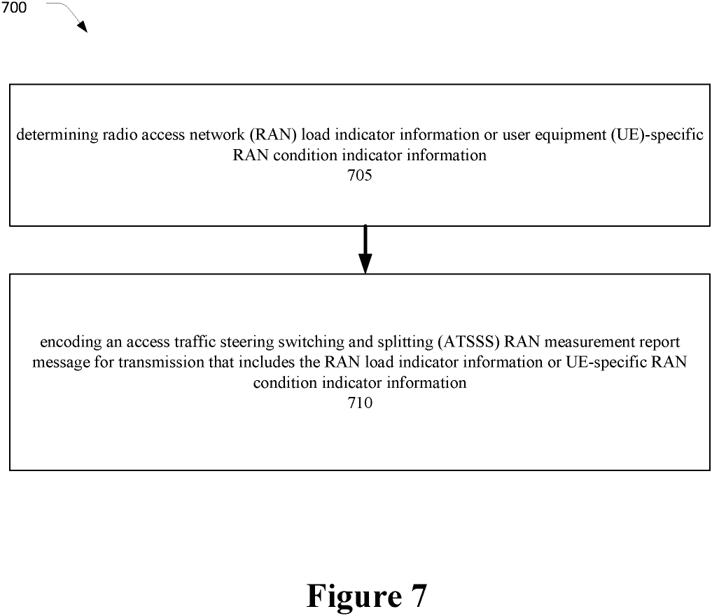

FIG. 7 illustrates another process in accordance with various embodiments. In this example, the process 700 includes, at 705, determining radio access network (RAN) load indicator information or user equipment (UE)-specific RAN condition indicator information. The process further includes, at 710, encoding an access traffic steering switching and splitting (ATSSS) RAN measurement report message for transmission that includes the RAN load indicator information or UE-specific RAN condition indicator information.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Example 1 may include a method of operating a 5G system which includes a UE, NG-RAN, AMF, SMF, UPF, TNGF, N3IWF, WLAN Access and other essential elements as described in 3GPP TS 23.501, v. 16.4.0, 2020-03-27, and TS 23.502, v. 16.4.0, 2020-03-27.

Example 2 may include the method of example 1 or some other example herein, where an ATSSS RAN measurement report is sent by NG-RAN to AMF, an ATSSS RAN measurement report is sent by TNGF to AMF and additional in-band UE ATSSS RAN measurement report is sent over PMF messaging from UE to the UPF, wherein the RAN measurement reports include the Radio Access Network load indicator.

Example 3 may include the method of example 2 or some other example herein, where the Radio Access Network load indicator includes the cell ID and the total PRB usage in the DL and/or UL of the corresponding cell.

Example 4 may include the method of example 2 or some other example herein, where the Radio Access Network load indicator includes the cell ID, quality-of-service class indicator(s), and the PRB usage in the DL and/or UL of the corresponding cell for the indicated QoS class(es).

Example 5 may include the method of example 2 or some other example herein, where the Radio Access Network load indicator includes the WLAN BSS ID, the BSS load element, which includes STA count and Channel Utilization, and Estimated Service Parameters, which include estimated throughput for available access categories, estimate of air time fraction, Block Ack Window size, data PPDU duration target.

Example 6 may include the 5G system of example 1 or some other example herein, where an ATSSS RAN measurement report is sent by NG-RAN to AMF, an ATSSS RAN measurement report is sent by TNGF to AMF and additional in-band UE ATSSS RAN measurement report is sent over PMF messaging from UE to the UPF, wherein the RAN measurement reports include the UE-specific RAN condition indicator.

Example 7 may include the method of example 6 or some other example herein, where the UE-specific RAN condition indicator includes the UE ID and radio quality indicator of the UE.

Example 8 may include the method of example 7 or some other example herein, where the radio quality indicator for cellular radio can be UE RSRP measurement, UE RSRQ measurement, UE average CQI index, UE median CQI index and UE average data rate.

Example 9 may include the method of example 7 or some other example herein, where the radio quality indicator for Wi-Fi radio can be STA RSSI, average/median PHY rate, estimated MAC Data Rate in DL, estimated MAC Data Rate in UL, STA uplink RSSI.

Example 10 may include the method of example 6 or some other example herein, where the UE-specific RAN condition indicator includes UE ID and UE per RAT radio resource utilization, wherein UE per RAT radio resource utilization includes average PRB usage of the UE and STA utilization level.

Example 11 may include the method of examples 2 to 5 or some other example herein, where SMF determines the traffic split percentage of an SDF carried over MA PDU session via a mapping function from Radio Access Network load indicator(s) to traffic split percentage, wherein the mapping can be done by categorizing Radio Access Network load indicator(s) according to some RAN-load threshold(s) and assigning each category a traffic split percentage setting, and updates N4 and ATSSS rules when traffic split percentage changes.

Example 12 may include the method of examples 2 to 5 or some other example herein, where SMF decreases the traffic split percentage of a an SDF carried over MA PDU session for one access by a step size if the Radio Access Network load indicator for the access is above a RAN-load threshold, increases the traffic split percentage for one access by another step size if the Radio Access Network load indicator for the access is below another RAN-load threshold, and updates N4 and ATSSS rules when traffic split percentage changes.

Example 13 may include the method of examples 6 to 10 or some other example herein, where SMF configures Priority based with RAN measurement ATSSS rule for an SDF carried over MA PDU session, where the priority access is determined by comparing the UE-specific RAN condition indicator(s) of the MA-PDU UE with some UE-specific RAN condition threshold(s).

Example 14 may include the method of example 13 or some other example herein, where, when congestion over one access is detected, SMF updates the N4 and ATSSS rules with modified traffic split percentage of a MA-PDU SDF, wherein the split percentage of the congested access is decreased by certain step size and the split percentage of the non-congested access is increased by certain step size, and wherein the MA-PDU SDF belongs to a UE whose UE-specific RAN condition indicator of the non-congested access surpasses some UE-specific RAN condition threshold and/or whose UE-specific RAN condition indicator of the congested access falls below some UE-specific RAN condition threshold.

Example 15 may include the method of examples 12 and 14 or some other example herein, where the step sizes for traffic split percentage update can be configuration parameters as part of PCC rules provided by PCF.

Example 16 may include the method of examples 2, 3, 4, 5 and 14 or some other example herein, where SMF detects the congestion over an access when the Radio Access Network load indicator of the access exceeds a RAN-load threshold.

Example 17 may include examples 11 to 13 and 17 or some other example herein, where the RAN-load thresholds can be configuration parameters as part of PCC rules provided by PCF.

Example 18 may include the method of example 13 or some other example herein, where, when congestion over one access is detected, UPF and UE update the traffic split percentage of a MA-PDU SDF by decreasing split percentage of the congested access and increase the split percentage of the non-congested access by certain step size, wherein the MA-PDU SDF belongs to a UE whose UE-specific RAN condition indicator of the non-congested access surpasses some UE-specific RAN condition threshold and/or whose UE-specific RAN condition indicator of the congested access falls below some UE-specific RAN condition threshold.

Example 19 may include the method of example 18 or some other example herein, where the step sizes for traffic split percentage update can be configuration parameters as part of ATSSS and N4 rules provided by SMF.

Example 20 may include the method of examples 2, 3, 4, 5 and 18 or some other example herein, where UE and UPF detect the congestion over an access when the Radio Access Network load indicator of the access exceeds a RAN-load threshold.

Example 21 may include the method of example 20 or some other example herein, where the RAN-load thresholds can be configuration parameters as part of ATSSS and N4 rules provided by SMF.

Example 22 may include the method of examples 14 and 18 or some other example herein, where the UE-specific RAN condition thresholds can be configuration parameters as part of PCC rules provided by PCF.

Example 23 may include the method of example 18 or some other example herein, where the UE-specific RAN condition thresholds can be configuration parameters as part of ATSSS and N4 rules provided by SMF.

Example 24 includes a method comprising:
determining radio access network (RAN) load indicator information or user equipment (UE)-specific RAN condition indicator information; and
encoding a measurement report message that includes the RAN load indicator information or UE-specific RAN condition indicator information for transmission.

Example 25 includes the method of example 24 or some other example herein, wherein the measurement report message is an access traffic steering switching and splitting (ATSSS) RAN measurement report.

Example 26 includes the method of example 24 or some other example herein, wherein the RAN load indicator information includes a radio resource utilization measurement.

Example 27 includes the method of example 26 or some other example herein, wherein the radio resource utilization measurement is a total physical resource block (PRB) usage indicator.

Example 28 includes the method of example 27 or some other example herein, wherein the total PRB usage indicator indicates PRB usage per traffic class.

Example 29 includes the method of example 24 or some other example herein, wherein the RAN load indicator information includes an indication of a basic service set (BSS) load element for an access point (AP) beacon message.

Example 30 includes the method of example 29 or some other example herein, wherein the BSS load element includes an indication of a station (STA) count or an indication of channel utilization.

Example 31 includes the method of example 24 or some other example herein, wherein the RAN load indicator information includes an estimated service parameter (ESP).

Example 32 includes the method of example 24 or some other example herein, wherein the RAN load indicator information is received via a wireless local area network (WLAN) through N2 signaling or by STA via protected management frame (PMF) in-band signaling.

Example 33 includes the method of example 24 or some other example herein, wherein the UE-specific RAN condition indicator information includes an indication of UE radio signal quality.

Example 34 includes the method of example 33 or some other example herein, wherein the indication of UE radio signal quality includes: RSRP (Reference Signal Received Power), RSRQ (Reference Signal Received Quality), average/median CQI (Channel Quality Indicator) index or an average medium access control (MAC) data rate.

Example 35 includes the method of example 24 or some other example herein, wherein the indication of UE radio signal quality includes: an indication of an estimated downlink MAC data rate, an indication of an estimated uplink MAC data rate, or a measured uplink received signal strength indicator (RSSI).

Example 36 includes the method of example 24 or some other example herein, wherein the UE-specific RAN condition indicator includes an indication of a UE per radio access technology (RAT) utilization.

Example 37 includes the method of example 36 or some other example herein, wherein the UE per RAT utilization is based on a level of efficiency of radio usage of a UE with a multiple access protocol data unit (MA-PDU) session.

Example 38 includes the method of any of examples 24-37 or some other example herein, wherein the method is performed by a user equipment (UE) or portion thereof.

Example 39 includes the method of any of examples 24-37 or some other example herein, wherein the method is performed by a next-generation NodeB (gNB) or portion thereof.

Example X1 includes an apparatus comprising:
memory to store radio access network (RAN) load indicator information or user equipment (UE)-specific RAN condition indicator information; and
processing circuitry, coupled with the memory, to:
   retrieve the RAN load indicator information or UE-specific RAN condition indicator information from the memory; and
   encode a measurement report message for transmission that includes the RAN load indicator information or UE-specific RAN condition indicator information.

Example X2 includes the apparatus of example X1 or some other example herein, wherein the measurement report message is an access traffic steering switching and splitting (ATSSS) RAN measurement report.

Example X3 includes the apparatus of example X1 or some other example herein, wherein the RAN load indicator information includes a radio resource utilization measurement.

Example X4 includes the apparatus of example X3 or some other example herein, wherein the radio resource utilization measurement is a total physical resource block (PRB) usage indicator that is to indicate PRB usage per traffic class.

Example X5 includes the apparatus of example X1 or some other example herein, wherein the RAN load indicator information includes an indication of a basic service set (BSS) load element for an access point (AP) beacon message.

Example 6 includes the apparatus of example X5 or some other example herein, wherein the BSS load element includes an indication of a station (STA) count or an indication of channel utilization.

Example X7 includes the apparatus of example X1 or some other example herein, wherein the RAN load indicator information includes an estimated service parameter (ESP).

Example X8 includes the apparatus of example X1 or some other example herein, wherein the RAN load indicator information is received via a wireless local area network (WLAN) through N2 signaling or by STA via protected management frame (PMF) in-band signaling.

Example X9 includes the apparatus of any of examples X1-X8, wherein the UE-specific RAN condition indicator information comprises an indication of UE radio signal quality that includes an indication of: reference signal received power (RSRP), reference signal received quality (RSRQ), an average or median channel quality indicator (CQI) index, or an average medium access control (MAC) data rate.

Example X10 includes the apparatus of example X9 or some other example herein, wherein the indication of UE radio signal quality includes: an indication of an estimated downlink MAC data rate, an indication of an estimated uplink MAC data rate, or a measured uplink received signal strength indicator (RSSI).

Example X11 includes the apparatus of any of examples X1-X10 or some other example herein, wherein the UE-specific RAN condition indicator includes an indication of a UE per radio access technology (RAT) utilization that is based on a level of efficiency of radio usage of a UE with a multiple access protocol data unit (MA-PDU) session.

Example X12 includes one or more computer-readable media storing instructions that, when executed by one or more processors, cause a next-generation NodeB (gNB) to:
determine radio access network (RAN) load indicator information or user equipment (UE)-specific RAN condition indicator information; and
encode a measurement report message for transmission that includes the RAN load indicator information or UE-specific RAN condition indicator information.

Example X13 includes the one or more computer-readable media of example X12 or some other example herein, wherein the measurement report message is an access traffic steering switching and splitting (ATSSS) RAN measurement report.

Example X14 includes the one or more computer-readable media of example X12 or some other example herein, wherein the RAN load indicator information includes a radio resource utilization measurement that includes a total physical resource block (PRB) usage indicator that is to indicate PRB usage per traffic class.

Example X15 includes the one or more computer-readable media of example X12 or some other example herein, wherein the RAN load indicator information includes an estimated service parameter (ESP), or an indication of a basic service set (BSS) load element for an access point (AP) beacon message, wherein the BSS load element includes an indication of a station (STA) count or an indication of channel utilization.

Example X16 includes the one or more computer-readable media of example X12 or some other example herein, wherein the RAN load indicator information is received via a wireless local area network (WLAN) through N2 signaling or by STA via protected management frame (PMF) in-band signaling.

Example X17 includes the one or more computer-readable media of any of examples X12-X16 or some other example herein, wherein the UE-specific RAN condition indicator information comprises an indication of UE radio signal quality that includes an indication of: reference signal received power (RSRP), reference signal received quality (RSRQ), an average or median channel quality indicator (CQI) index, or an average medium access control (MAC) data rate.

Example X18 includes the one or more computer-readable media of example X17 or some other example herein, wherein the indication of UE radio signal quality includes: an indication of an estimated downlink MAC data rate, an indication of an estimated uplink MAC data rate, or a measured uplink received signal strength indicator (RSSI).

Example X19 includes the one or more computer-readable media of any of examples X12-X18, wherein the UE-specific RAN condition indicator includes an indication of a UE per radio access technology (RAT) utilization that is based on a level of efficiency of radio usage of a UE with a multiple access protocol data unit (MA-PDU) session.

Example X20 includes one or more computer-readable media storing instructions that, when executed by one or more processors, cause a user equipment (UE) to:
determine radio access network (RAN) load indicator information or user equipment (UE)-specific RAN condition indicator information; and
encode an access traffic steering switching and splitting (ATSSS) RAN measurement report message for transmission that includes the RAN load indicator information or UE-specific RAN condition indicator information.

Example X21 includes the one or more computer-readable media of example X20 or some other example herein, wherein the RAN load indicator information includes:
a radio resource utilization measurement that includes a total physical resource block (PRB) usage indicator that is to indicate PRB usage per traffic class; or
an estimated service parameter (ESP); or
a basic service set (BSS) load element for an access point (AP) beacon message, wherein the BSS load element includes an indication of a station (STA) count or an indication of channel utilization.

Example X22 includes the one or more computer-readable media of example X20 or some other example herein, wherein the RAN load indicator information is received via a wireless local area network (WLAN) through N2 signaling or by STA via protected management frame (PMF) in-band signaling.

Example X23 includes the one or more computer-readable media of any of examples X20-X22 or some other example herein, wherein the UE-specific RAN condition indicator information comprises an indication of UE radio signal quality that includes an indication of: reference signal received power (RSRP), reference signal received quality (RSRQ), an average or median channel quality indicator (CQI) index, or an average medium access control (MAC) data rate.

Example X24 includes the one or more computer-readable media of any of examples X20-X23 or some other example herein, wherein the UE-specific RAN condition indicator includes an indication of a UE per radio access technology (RAT) utilization that is based on a level of efficiency of radio usage of a UE with a multiple access protocol data unit (MA-PDU) session.

Example Z01 may include an apparatus comprising means to perform one or more elements of a method described in or related to any of examples 1-X24, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples 1- X24, or any other method or process described herein.

Example Z03 may include an apparatus comprising logic, modules, or circuitry to perform one or more elements of a method described in or related to any of examples 1- X24, or any other method or process described herein.

Example Z04 may include a method, technique, or process as described in or related to any of examples 1- X24, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples 1- X24, or portions thereof.

Example Z06 may include a signal as described in or related to any of examples 1-X24, or portions or parts thereof.

Example Z07 may include a datagram, packet, frame, segment, protocol data unit (PDU), or message as described in or related to any of examples 1- X24, or portions or parts thereof, or otherwise described in the present disclosure.

Example Z08 may include a signal encoded with data as described in or related to any of examples 1- X24, or portions or parts thereof, or otherwise described in the present disclosure.

Example Z09 may include a signal encoded with a datagram, packet, frame, segment, protocol data unit (PDU), or message as described in or related to any of examples 1- X24, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples 1- X24, or portions thereof.

Example Z11 may include a computer program comprising instructions, wherein execution of the program by a processing element is to cause the processing element to carry out the method, techniques, or process as described in or related to any of examples 1- X24, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Abbreviations

Unless used differently herein, terms, definitions, and abbreviations may be consistent with terms, definitions, and abbreviations defined in 3GPP TR 21.905 v16.0.0 (2019-06). For the purposes of the present document, the following abbreviations may apply to the examples and embodiments discussed herein.

| | | |
|---|---|---|
| 3GPP Third Generation Partnership Project 4G Fourth Generation | ASN.1 Abstract Syntax Notation One AUSF Authentication Server Function AWGN Additive | CAPEX CAPital |
| | | Expenditure CBRA Contention Based Random Access CC Component Carrier, Country |
| 5G Fifth Generation 5GC 5G Core network ACK Acknowledgement | | |
| | White Gaussian Noise BAP Backhaul Adaptation Protocol BCH Broadcast | |
| | | Code, Cryptographic Checksum CCA Clear Channel Assessment CCE Control Channel |
| AF Application Function AM Acknowledged Mode AMBRAggregate | | |
| | Channel BER Bit Error Ratio BFD Beam Failure Detection BLER Block Error Rate | |
| | | Element CCCH Common Control Channel CE Coverage Enhancement |
| Maximum Bit Rate AMF Access and Mobility Management Function | | |
| | BPSK Binary Phase Shift Keying BRAS Broadband Remote Access Server | |
| | | CDM Content Delivery Network CDMA Code-Division Multiple Access |
| AN Access Network ANR Automatic Neighbour Relation AP Application Protocol, Antenna | | |
| | BSS Business Support System BS Base Station BSR Buffer Status Report | |
| | | CFRA Contention Free Random Access CG Cell Group CI Cell Identity CID Cell-ID (e.g., |
| Port, Access Point API Application Programming Interface APN Access Point Name | | |
| | BW Bandwidth BWP Bandwidth Part C-RNTI Cell Radio Network Temporary Identity | |
| | | positioning method) CIM Common Information Model CIR Carrier to Interference Ratio |
| ARP Allocation and Retention Priority ARQ Automatic Repeat Request AS Access Stratum | | |
| | CA Carrier Aggregation, Certification Authority | |
| | | CK Cipher Key CM Connection Management, |
| Conditional Mandatory CMAS Commercial Mobile Alert Service | CRAN Cloud Radio Access Network, | CSMA/CA CSMA with collision avoidance CSS Common Search |
| | Cloud RAN CRB Common Resource Block CRC Cyclic Redundancy Check | |
| | | Space, Cell- specific Search Space CTS Clear-to-Send CW Codeword CWS Contention |
| CMD Command CMS Cloud Management System CO Conditional Optional | | |
| | CRI Channel-State Information Resource Indicator, CSI-RS Resource Indicator | |
| | | Window Size D2D Device-to-Device DC Dual Connectivity, Direct Current |
| CoMP Coordinated Multi-Point CORESET Control Resource Set COTS Commercial Off- | | |
| | C-RNTI Cell RNTI CS Circuit Switched CSAR Cloud Service Archive CSI Channel-State | |
| | | DCI Downlink Control Information DF Deployment Flavour DL Downlink |
| The-Shelf CP Control Plane, Cyclic Prefix, Connection Point CPD Connection Point | | |
| | Information CSI-IM CSI Interference Measurement CSI-RS CSI | |
| | | DMTF Distributed Management Task Force DPDK Data Plane Development Kit DM-RS, DMRS |
| Descriptor CPE Customer Premise Equipment CPICHCommon Pilot Channel | | |
| | Reference Signal CSI-RSRP CSI reference signal received power CSI-RSRQ CSI | |
| | | Demodulation Reference Signal DN Data network DRB Data Radio Bearer DRS Discovery |
| CQI Channel Quality Indicator CPU CSI processing unit, Central Processing Unit | | |
| | reference signal received quality CSI-SINR CSI signal-to-noise and interference ratio | |
| | | Reference Signal DRX Discontinuous Reception DSL Domain Specific Language. Digital |
| C/R Command/Respon se field bit | | |
| | CSMA Carrier Sense Multiple Access | |
| | | Subscriber Line |
| DSLAM DSL Access Multiplexer DwPTS Downlink Pilot Time Slot | EMS Element Management System eNB evolved NodeB, E-UTRAN Node B EN-DC E-UTRA- | E-UTRAN Evolved UTRAN |
| | | EV2X Enhanced V2X F1AP F1 Application Protocol F1-C F1 Control plane interface |
| E-LAN Ethernet Local Area Network E2E End-to-End ECCA extended clear channel | | |
| | NR Dual Connectivity EPC Evolved Packet Core EPDCCH enhanced | |
| | | F1-U F1 User plane interface FACCH Fast Associated Control CHannel |
| assessment, extended CCA ECCE Enhanced Control Channel Element, Enhanced CCE | | |
| | PDCCH, enhanced Physical Downlink Control Cannel EPRE Energy per | |
| | | FACCH/F Fast Associated Control Channel/Full rate FACCH/H Fast Associated Control |
| ED Energy Detection EDGE Enhanced Datarates for GSM Evolution (GSM Evolution) | | |
| | resource element EPS Evolved Packet System EREG enhanced REG, enhanced resource | |
| | | Channel/Half rate FACH Forward Access Channel FAUSCH Fast Uplink Signalling |
| EGMF Exposure Governance Management Function EGPRS Enhanced | | |
| | element groups ETSI European Telecommunicatio ns Standards Institute ETWS Earthquake and ; | |
| | | Channel FB Functional Block FBI Feedback Information FCC Federal |
| GPRS EIR Equipment Identity Register eLAA enhanced Licensed Assisted | | |
| | Tsunami Warning System eUICC embedded UICC, embedded Universal Integrated Circuit | |
| | | Communications Commission FCCH Frequency Correction CHannel FDD Frequency |
| Access, enhanced LAA EM Element Manager eMBB Enhanced Mobile Broadband | | |
| | Card E-UTRA Evolved UTRA | |
| | | Division Duplex |
| FDM Frequency Division Multiplex FDMA Frequency Division Multiple | Sputnikovaya Sistema (Engl.: Global Navigation Satellite System) gNB Next Generation | GUTI Globally Unique Temporary UE |
| | | Identity HARQ Hybrid ARQ, Hybrid Automatic Repeat Request HANDO Handover |
| Access FE Front End FEC Forward Error Correction FFS For Further Study | | |
| | NodeB gNB-CU gNB-centralized unit, Next Generation NodeB centralized unit | |
| | | HFN HyperFrame Number HHO Hard Handover HLR Home Location Register |
| FFT Fast Fourier Transformation feLAA further enhanced Licensed Assisted Access, further | | |
| | gNB-DU gNB-distributed unit, Next Generation NodeB distributed unit GNSS Global Navigation | |
| | | HN Home Network HO Handover HPLMN Home Public Land Mobile Network |
| enhanced LAA FN Frame Number FPGA Field-Programmable Gate Array | | |
| | Satellite System GPRS General Packet Radio Service GSM Global System for Mobile | |
| | | HSDPA High Speed Downlink Packet Access HSN Hopping Sequence Number |
| FR Frequency Range G-RNTI GERAN Radio Network Temporary Identity | | |
| | Communications, Groupe Special Mobile GTP GPRS Tunneling Protocol | |
| | | HSPA High Speed Packet Access HSS Home Subscriber Server HSUPA High |
| GERAN GSM EDGE RAN, GSM EDGE Radio Access Network | | |
| | GTP-UGPRS Tunnelling Protocol for User Plane GTS Go To Sleep Signal (related to | |
| | | Speed Uplink Packet Access HTTP Hyper Text Transfer Protocol HTTPS Hyper |
| GGSN Gateway GPRS Support Node GLONASS GLObal’naya NAvigatsionnaya | | |
| | WUS) GUMMEI Globally Unique MME Identifier | |
| | | Text Transfer Protocol Secure (https is |
| http/1.1 over SSL, i.e. port 443) I-Block Information Block | IMC IMS Credentials IMEI International Mobile Equipment Identity IMGI International | ISDN Integrated Services Digital Network |
| | | ISIM IM Services Identity Module ISO International Organisation for Standardisation |
| ICCID Integrated Circuit Card Identification IAB Integrated Access and Backhaul ICIC Inter-Cell | | |
| | mobile group identity IMPI IP Multimedia Private Identity IMPU IP Multimedia PUblic identity | |
| | | ISP Internet Service Provider IWF Interworking-Function I-WLAN |
| Interference Coordination ID Identity, identifier IDFT Inverse Discrete Fourier Transform | | |
| | IMS IP Multimedia Subsystem IMSI International Mobile Subscriber Identity | |
| | | Interworking WLAN Constraint length of the convolutional code, USIM Individual |
| IE Information element IBE In-Band Emission IEEE Institute of | | |
| | IoT Internet of Things IP Internet Protocol Ipsec IP Security, Internet Protocol Security | |
| | | key kB Kilobyte (1000 bytes) kbps kilo-bits per second |
| Electrical and Electronics Engineers IEI Information Element Identifier IEIDL Information | | |
| | IP-CAN IP-Connectivity Access Network IP-M IP Multicast IPv4 Internet Protocol | |
| | | Kc Ciphering key Ki Individual subscriber authentication key KPI Key Performance |
| Element Identifier Data Length IETF Internet Engineering Task Force | | |
| | Version 4 IPv6 Internet Protocol Version 6 IR Infrared IS In Sync | |
| | | Indicator KQI Key Quality Indicator KSI Key Set Identifier ksps kilo-symbols per |
| IF Infrastructure IM Interference Measurement, Intermodulation, IP Multimedia | | |
| | IRP Integration Reference Point | |
| | | second |
| KVM Kernel Virtual Machine L1 Layer 1 (physical layer) | LTE Long Term | MBSFN Multimedia Broadcast multicast |
| | Evolution LWA LTE-WLAN aggregation LWIP LTE/WLAN Radio Level Integration | |
| | | service Single Frequency Network MCC Mobile Country Code MCG Master Cell Group |
| L1-RSRP Layer 1 reference signal received power L2 Layer 2 (data link layer) | | |
| | with IPsec Tunnel LTE Long Term Evolution M2M Machine-to-Machine | |
| | | MCOT Maximum Channel Occupancy Time MCS Modulation and coding scheme |
| L3 Layer 3 (network layer) LAA Licensed Assisted Access LAN Local Area | | |
| | MAC Medium Access Control (protocol layering context) MAC Message authentication code | |
| | | MDAF Management Data Analytics Function MDAS Management Data Analytics Service MDT Minimization of |
| Network LBT Listen Before Talk LCM LifeCycle Management | | |
| | (security/encryption context) MAC-A MAC used for authentication and key agreement (TSG T | |
| | | Drive Tests ME Mobile Equipment MeNB master eNB MER Message Error Ratio |
| LCR Low Chip Rate LCS Location Services LCID Logical Channel ID LI Layer Indicator | | |
| | WG3 context) MAC-IMAC used for data integrity of signalling messages (TSG T WG3 context) | |
| | | MGL Measurement Gap Length MGRP Measurement Gap Repetition Period MIB Master |
| LLC Logical Link Control, Low Layer Compatibility LPLMN Local PLMN | | |
| | MANO Management and Orchestration MBMS Multimedia | |
| | | Information Block, Management Information Base MIMO Multiple Input Multiple Output |
| LPP LTE Positioning Protocol LSB Least Significant Bit | | |
| | Broadcast and Multicast Service | |
| MLC Mobile Location Centre MM Mobility Management | MSI Minimum System Information, MCH Scheduling Information MSID Mobile Station | NC-JT Non- |
| | | Coherent Joint Transmission NEC Network Capability Exposure NE-DC NR-E- |
| MME Mobility Management Entity MN Master Node MnS Management Service | | |
| | Identifier MSIN Mobile Station Identification Number MSISDN Mobile | |
| | | UTRADual Connectivity NEF Network Exposure Function NF Network Function |
| MO Measurement Object, Mobile Originated MPBCH MTC Physical Broadcast | | |
| | Subscriber ISDN Number MT Mobile Terminated, Mobile Termination | |
| | | NFP Network Forwarding Path NFPD Network Forwarding Path Descriptor |
| CHannel MPDCCH MTC Physical Downlink Control CHannel MPDSCH MTC | | |
| | MTC Machine-Type Communications mMTCmassive MTC, massive Machine-Type Communications | |
| | | NFV Network Functions Virtualization NFVI NFV Infrastructure |
| Physical Downlink Shared CHannel MPRACH MTC Physical Random Access CHannel | | |
| | MU-MIMO Multi User MIMO MWUS MTC wake-up signal, MTC WUS | |
| | | NFVO NFV Orchestrator NG Next Generation, Next Gen NGEN-DC NG-RAN E-UTRA-NR Dual |
| MPUSCH MTC Physical Uplink Shared Channel MPLS MultiProtocol Label Switching | | |
| | NACKNegative Acknowledgement NAI Network Access Identifier NAS Non-Access | |
| | | Connectivity NM Network Manager NMS Network Management System N-PoP Network Point of |
| MS Mobile Station MSB Most Significant Bit MSC Mobile Switching Centre | | |
| | Stratum, Non- Access Stratum layer NCT Network Connectivity Topology | |
| | | Presence NMIB, N-MIB Narrowband MIB |
| NPBCH Narrowband Physical Broadcast CHannel | NS Network Service NSA Non-Standalone operation mode NSD Network Service Descriptor | OSI Other System |
| | | Information OSS Operations Support System OTA over-the-air PAPR Peak-to-Average |
| NPDCCH Narrowband Physical Downlink Control CHannel NPDSCH | | |
| | NSR Network Service Record NSSAINetwork Slice Selection Assistance Information | |
| | | Power Ratio PAR Peak to Average Ratio PBCH Physical Broadcast Channel |
| Narrowband Physical Downlink Shared CHannel NPRACH Narrowband | | |
| | S-NNSAI Single-NSSAI NSSF Network Slice Selection Function NW Network | |
| | | PC Power Control, Personal Computer PCC Primary Component Carrier, Primary CC |
| Physical Random Access CHannel NPUSCH Narrowband Physical Uplink | | |
| | NWUSNarrowband wake-up signal, Narrowband WUS NZP Non-Zero Power O&M Operation and | |
| | | PCell Primary Cell PCI Physical Cell ID, Physical Cell Identity PCEF Policy and |
| Shared CHannel NPSS Narrowband Primary Synchronization Signal | | |
| | Maintenance ODU2 Optical channel Data Unit - type 2 OFDM Orthogonal Frequency Division | |
| | | Charging Enforcement Function PCF Policy Control Function |
| NSSS Narrowband Secondary Synchronization Signal NR New Radio, | | |
| | Multiplexing OFDMA Orthogonal Frequency Division Multiple Access | |
| | | PCRF Policy Control and Charging Rules Function PDCP Packet Data Convergence Protocol, |
| Neighbour Relation NRF NF Repository Function NRS Narrowband Reference Signal | | |
| | OOB Out-of-band OOS Out of Sync OPEX OPerating EXpense | |
| | | Packet Data Convergence Protocol layer |
| PDCCH Physical Downlink Control Channel PDCP Packet Data | PNFR Physical Network Function Record POC PTT over Cellular PP, PTP Point-to-Point | PSSCH Physical Sidelink Shared |
| | | Channel PSCell Primary SCell PSS Primary Synchronization Signal |
| Convergence Protocol PDN Packet Data Network, Public Data Network PDSCH Physical | | |
| | PPP Point-to-Point Protocol PRACH Physical RACH PRB Physical resource | |
| | | PSTN Public Switched Telephone Network PT-RS Phase-tracking reference signal PTT Push-to-Talk |
| Downlink Shared Channel PDU Protocol Data Unit PEI Permanent | | |
| | block PRG Physical resource block group ProSe Proximity Services, Proximity- | |
| | | PUCCH Physical Uplink Control Channel PUSCH Physical Uplink Shared |
| Equipment Identifiers PFD Packet Flow Description P-GW PDN Gateway PHICH Physical | | |
| | Based Service PRS Positioning Reference Signal PRR Packet Reception Radio | |
| | | Channel QAM Quadrature Amplitude Modulation QCI QoS class of |
| hybrid-ARQ indicator channel PHY Physical layer PLMN Public Land Mobile Network | | |
| | PS Packet Services PSBCH Physical Sidelink Broadcast Channel PSDCH Physical | |
| | | identifier QCL Quasi co-location QFI QoS Flow ID, QoS Flow Identifier QoS Quality of Service |
| PIN Personal Identification Number PM Performance Measurement PMI Precoding Matrix | | |
| | Sidelink Downlink Channel PSCCH Physical Sidelink Control Channel | |
| | | QPSK Quadrature (Quaternary) Phase Shift Keying QZSS Quasi-Zenith Satellite System |
| Indicator PNF Physical Network Function PNFD Physical Network Function Descriptor | | |
| | PSFCH Physical Sidelink Feedback Channel | |
| | | RA-RNTI Random Access RNTI |
| RAB Radio Access Bearer, Random Access Burst RACH Random Access | RLC Radio Link Control, Radio | RRM Radio Resource Management RS Reference Signal |
| | Link Control layer RLC AM RLC Acknowledged Mode RLC UM RLC Unacknowledged Mode | |
| | | RSRP Reference Signal Received Power RSRQ Reference Signal Received Quality RSSI Received Signal |
| Channel RADIUS Remote Authentication Dial In User Service RAN Radio Access | | |
| | RLF Radio Link Failure RLM Radio Link Monitoring RLM-RS Reference | |
| | | Strength Indicator RSU Road Side Unit RSTD Reference Signal Time difference RTP Real Time |
| Network RAND RANDom number (used for authentication) RAR Random Access | | |
| | Signal for RLM RM Registration Management RMC Reference Measurement Channel | |
| | | Protocol RTS Ready-To-Send RTT Round Trip Time Rx Reception, Receiving, Receiver |
| Response RAT Radio Access Technology RAU Routing Area Update | | |
| | RMSI Remaining MSI, Remaining Minimum System Information RN Relay Node | |
| | | S1AP S1 Application Protocol S1-MME S1 for the control plane S1-U S1 for the user |
| RB Resource block, Radio Bearer RBG Resource block group REG Resource Element | | |
| | RNC Radio Network Controller RNL Radio Network Layer RNTI Radio Network | |
| | | plane S-GW Serving Gateway S-RNTI SRNC Radio Network Temporary |
| Group Rel Release REQ REQuest RF Radio Frequency RI Rank Indicator | | |
| | Temporary Identifier ROHC RObust Header Compression RRC Radio Resource Control, Radio | |
| | | Identity S-TMSI SAE Temporary Mobile Station Identifier SA Standalone |
| RIV Resource indicator value RL Radio Link | | |
| | Resource Control layer | |
| | | operation mode |
| SAE System Architecture Evolution SAP Service Access Point | SDP Session Description Protocol SDSF Structured Data Storage Function SDU Service Data Unit | SiP System in |
| | | Package SL Sidelink SLA Service Level Agreement SM Session |
| SAPD Service Access Point Descriptor SAPI Service Access Point Identifier SCC Secondary | | |
| | SEAF Security Anchor Function SeNB secondary eNB SEPP Security Edge Protection Proxy | |
| | | Management SMF Session Management Function SMS Short Message Service |
| Component Carrier, Secondary CC SCell Secondary Cell SC-FDMA Single Carrier Frequency | | |
| | SFI Slot format indication SFTD Space-Frequency Time Diversity, SFN and frame timing | |
| | | SMSF SMS Function SMTC SSB-based Measurement Timing Configuration SN Secondary Node, |
| Division Multiple Access SCG Secondary Cell Group SCM Security Context | | |
| | difference SFN System Frame Number or Single Frequency Network | |
| | | Sequence Number SoC System on Chip SON Self⁻Organizing Network SpCell Special Cell |
| Management SCS Subcarrier Spacing SCTP Stream Control Transmission | | |
| | SgNB Secondary gNB SGSN Serving GPRS Support Node S-GW Serving Gateway SI System | |
| | | SP-CSI-RNTISemi-Persistent CSI RNTI SPS Semi-Persistent Scheduling SQN Sequence number |
| Protocol SDAP Service Data Adaptation Protocol, Service Data Adaptation Protocol layer | | |
| | Information SI-RNTI System Information RNTI SIB System Information Block | |
| | | SR Scheduling Request SRB Signalling Radio Bearer SRS Sounding |
| SDL Supplementary Downlink SDNF Structured Data Storage Network Function | | |
| | SIM Subscriber Identity Module SIP Session Initiated Protocol | |
| | | Reference Signal SS Synchronization Signal |
| SSB SS Block SSBRI SSB Resource Indicator SSC Session and | TA Timing Advance, | TPC Transmit Power Control |
| | Tracking Area TAC Tracking Area Code TAG Timing Advance Group | |
| | | TPMI Transmitted Precoding Matrix Indicator TR Technical Report TRP, TRxP |
| Service Continuity SS-RSRP Synchronization Signal based Reference Signal Received | | |
| | TAU Tracking Area Update TB Transport Block TBS Transport Block Size | |
| | | Transmission Reception Point TRS Tracking Reference Signal TRx Transceiver |
| Power SS-RSRQ Synchronization Signal based Reference Signal Received | | |
| | TBD To Be Defined TCI Transmission Configuration Indicator TCP Transmission Communication | |
| | | TS Technical Specifications, Technical Standard TTI Transmission |
| Quality SS-SINR Synchronization Signal based Signal to Noise and Interference | | |
| | Protocol TDD Time Division Duplex TDM Time Division Multiplexing | |
| | | Time Interval Tx Transmission, Transmitting, Transmitter U-RNTI UTRAN |
| Ratio SSS Secondary Synchronization Signal SSSG Search Space Set | | |
| | TDMATime Division Multiple Access TE Terminal Equipment TEID Tunnel End Point | |
| | | Radio Network Temporary Identity UART Universal Asynchronous |
| Group SSSIF Search Space Set Indicator SST Slice/Service Types | | |
| | Identifier TFT Traffic Flow Template TMSI Temporary Mobile Subscriber | |
| | | Receiver and Transmitter UCI Uplink Control Information UE User Equipment |
| SU-MIMO Single User MIMO SUL Supplementary Uplink | | |
| | Identity TNL Transport Network Layer | |
| | | UDM Unified Data Management |
| UDP User Datagram Protocol UDR Unified Data Repository | USS UE-specific | VoIP Voice-over-IP, Voice-over- Internet Protocol VPLMN Visited |
| | search space UTRA UMTS Terrestrial Radio Access UTRAN Universal Terrestrial Radio | |
| UDSF Unstructured Data Storage Network Function UICC Universal Integrated Circuit | | Public Land Mobile Network VPN Virtual Private Network VRB Virtual Resource |
| | Access Network UwPTS Uplink Pilot Time Slot V2I Vehicle-to-Infrastruction | |
| Card UL Uplink UM Unacknowledged Mode UML Unified Modelling | | Block WiMAX Worldwide Interoperability for Microwave Access WLANWireless Local |
| | V2P Vehicle-to-Pedestrian V2V Vehicle-to-Vehicle V2X Vehicle-to- | |
| Language UMTS Universal Mobile Telecommunicatio ns System UP User Plane | | Area Network WMAN Wireless Metropolitan Area Network WPANWireless Personal |
| | everything VIM Virtualized Infrastructure Manager VL Virtual Link, VLAN Virtual LAN, | |
| UPF User Plane Function URI Uniform Resource Identifier URL Uniform Resource | | Area Network X2-C X2-Control plane X2-U X2-User plane XML eXtensible Markup Language |
| | Virtual Local Area Network VM Virtual Machine VNF Virtualized Network Function | |
| Locator URLLC Ultra-Reliable and Low Latency USB Universal Serial | | XRES EXpected user RESponse XOR eXclusive OR ZC Zadoff-Chu ZP Zero Power |
| | VNFFG VNF Forwarding Graph VNFFGD VNF Forwarding Graph Descriptor | |
| Bus USIM Universal Subscriber Identity Module | | |
| | VNFMVNF Manager | |

### Terminology

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields.

The term “field” refers to individual contents of an information element, or a data element that contains content.

The term “SMTC” refers to an SSB-based measurement timing configuration configured by SSB MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

1-22. (canceled)

23. An apparatus comprising:
memory to store radio access network (RAN) load indicator information or user equipment (UE)-specific RAN condition indicator information; and
processing circuitry, coupled with the memory, to:
retrieve the RAN load indicator information or UE-specific RAN condition indicator information from the memory; and
encode a measurement report message for transmission that includes the RAN load indicator information or UE-specific RAN condition indicator information.

24. The apparatus of claim 23, wherein the measurement report message is an access traffic steering switching and splitting (ATSSS) RAN measurement report.

25. The apparatus of claim 23, wherein the RAN load indicator information includes a radio resource utilization measurement.

26. The apparatus of claim 25, wherein the radio resource utilization measurement is a total physical resource block (PRB) usage indicator that is to indicate PRB usage per traffic class.

27. The apparatus of claim 23, wherein the RAN load indicator information includes an indication of a basic service set (BSS) load element for an access point (AP) beacon message.

28. The apparatus of claim 27, wherein the BSS load element includes an indication of a station (STA) count or an indication of channel utilization.

29. The apparatus of claim 23, wherein the RAN load indicator information includes an estimated service parameter (ESP).

30. The apparatus of claim 23, wherein the RAN load indicator information is received via a wireless local area network (WLAN) through N2 signaling.

31. The apparatus of claim 23, wherein the UE-specific RAN condition indicator information comprises an indication of UE radio signal quality that includes an indication of: reference signal received power (RSRP), reference signal received quality (RSRQ), an average or median channel quality indicator (CQI) index, or an average medium access control (MAC) data rate.

32. The apparatus of claim 31, wherein the indication of UE radio signal quality includes: an indication of an estimated downlink MAC data rate, an indication of an estimated uplink MAC data rate, or a measured uplink received signal strength indicator (RSSI).

33. ( The apparatus of claim 23, wherein the UE-specific RAN condition indicator includes an indication of a UE per radio access technology (RAT) utilization that is based on a level of efficiency of radio usage of a UE with a multiple access protocol data unit (MA-PDU) session.

34. One or more non-transitory computer-readable media storing instructions that, when executed by one or more processors, cause a next-generation NodeB (gNB) to:
determine radio access network (RAN) load indicator information or user equipment (UE)-specific RAN condition indicator information; and
encode a measurement report message for transmission that includes the RAN load indicator information or UE-specific RAN condition indicator information.

35. The one or more non-transitory computer-readable media of claim 34, wherein the measurement report message is an access traffic steering switching and splitting (ATSSS) RAN measurement report.

36. The one or more non-transitory computer-readable media of claim 34, wherein the RAN load indicator information includes a radio resource utilization measurement that includes a total physical resource block (PRB) usage indicator that is to indicate PRB usage per traffic class.

37. The one or more non-transitory computer-readable media of claim 34, wherein the UE-specific RAN condition indicator information comprises an indication of UE radio signal quality that includes an indication of: reference signal received power (RSRP), reference signal received quality (RSRQ), an average or median channel quality indicator (CQI) index, or an average medium access control (MAC) data rate.

38. The one or more non-transitory computer-readable media of claim 37, wherein the indication of UE radio signal quality includes: an indication of an estimated downlink MAC data rate, an indication of an estimated uplink MAC data rate, or a measured uplink received signal strength indicator (RSSI).

39. The one or more non-transitory computer-readable media of claim 34, wherein the UE-specific RAN condition indicator includes an indication of a UE per radio access technology (RAT) utilization that is based on a level of efficiency of radio usage of a UE with a multiple access protocol data unit (MA-PDU) session.

40. One or more non-transitory computer-readable media storing instructions that, when executed by one or more processors, cause a user equipment (UE) to:
determine radio access network (RAN) load indicator information or user equipment (UE)-specific RAN condition indicator information; and
encode an access traffic steering switching and splitting (ATSSS) RAN measurement report message for transmission that includes the RAN load indicator information or UE-specific RAN condition indicator information.

41. The one or more non-transitory computer-readable media of claim 40, wherein the RAN load indicator information includes:
a radio resource utilization measurement that includes a total physical resource block (PRB) usage indicator that is to indicate PRB usage per traffic class; or
an estimated service parameter (ESP); or
a basic service set (BSS) load element for an access point (AP) beacon message, wherein the BSS load element includes an indication of a station (STA) count or an indication of channel utilization.

42. The one or more non-transitory computer-readable media of claim 40, wherein the RAN load indicator information is received by STA via protected management frame (PMF) in-band signaling.

43. The one or more non-transitory computer-readable media of claim 40, wherein the UE-specific RAN condition indicator information comprises an indication of UE radio signal quality that includes an indication of: reference signal received power (RSRP), reference signal received quality (RSRQ), an average or median channel quality indicator (CQI) index, or an average medium access control (MAC) data rate.

44. The one or more non-transitory computer-readable media of claim 40, wherein the UE-specific RAN condition indicator includes an indication of a UE per radio access technology (RAT) utilization that is based on a level of efficiency of radio usage of a UE with a multiple access protocol data unit (MA-PDU) session.
